(19) United States
(12) Patent Application Publication
(10) Pub. No.: US 2025/0381862 A1
(43) Pub. Date: Dec. 18, 2025

(54) MOTOR VEHICLE COMPRISING AN ARRANGEMENT FOR UNLOCKING A LOCK OF A BONNET

(71) Applicant: AMPERE S.A.S., Boulogne Billancourt (FR)

(72) Inventors: Loïc BEZEAULT, Guyancourt (FR); Lionel GIRARDI, Guyancourt (FR)

(73) Assignee: AMPERE S.A.S., Boulogne Billancourt (FR)

(21) Appl. No.: 18/878,986

(22) PCT Filed: Jun. 20, 2023
(86) PCT No.: PCT/EP2023/066689

§ 371 Date: Feb. 10, 2025

(30) Foreign Application Priority Data
Jul. 6, 2022 (FR) FR2206922

(51) Int. Cl. B60L 53/16; E05B 79/20; E05B 83/24

(52) U.S. Cl. CPC B60L 53/16; E05B 79/20; E05B 83/24

(57) ABSTRACT

A motor vehicle includes an arrangement for unlocking a lock of a bonnet, in particular a front bonnet. The arrangement includes a gripping structure and a cable connecting the lock of the bonnet to the gripping structure. The gripping structure is accessible to a user from outside a passenger compartment of the motor vehicle and the cable is positioned entirely outside the passenger compartment of the motor vehicle.

The invention relates to a motor vehicle comprising an arrangement for unlocking a bonnet, in particular a front bonnet. The invention also relates to such an arrangement installed in a charging port of an electric vehicle. The invention also relates to a method for unlocking a bonnet of such a motor vehicle. The invention also relates to a method for charging a vehicle equipped with a charging port comprising an arrangement according to the invention.

In most motor vehicles, opening the front bonnet of the vehicle requires a manipulation to be performed in the passenger compartment of the vehicle, in particular pulling on a cable connected to a lock on the front bonnet. This technical solution has the advantage of being mechanically simple and of securing access to the engine area of the vehicle.

However, these days the front bonnet of a vehicle is opened much more frequently, in particular in the case of electric vehicles. To be specific, owing to the small size of their engine, some electric vehicles can have a space under the front bonnet of the vehicle that can be used as a storage compartment. Such a space may in particular be used to store cables for connecting the vehicle to a personal or communal charging terminal. A problem now relates to the ease of access to such a housing, notably for vehicles in which the power charging port is at a distance from this storage compartment. The vehicle user must thus move to different areas of the vehicle, first the passenger compartment to unlock the bonnet, then the bonnet to retrieve the charging cables, then the charging port to connect the cables to the terminal and to the vehicle.

There are technical solutions that simplify the opening of a front bonnet, such as unlocking of electric locks via a smartphone, or the use of electric actuators to open a front bonnet lock. However, implementing such solutions is costly.

The aim of the invention is to provide an arrangement for unlocking a bonnet, in particular a front bonnet of a vehicle, and a method for unlocking a bonnet of a vehicle that overcome the above drawbacks and improve the arrangements for unlocking and methods for unlocking a bonnet known from the prior art. In particular, the invention makes it possible to produce an arrangement and a method which are simple, inexpensive and reliable and which allow simplified and secure opening of a front bonnet.

The invention relates to a motor vehicle comprising an arrangement for unlocking a lock of a bonnet, in particular a front bonnet, the arrangement comprising a gripping means and a cable connecting the lock of the bonnet to the gripping means, wherein the gripping means is accessible to a user from outside a passenger compartment of the motor vehicle and the cable is positioned entirely outside the passenger compartment of the motor vehicle.

The vehicle forming the subject matter of the invention may also include the following features, independently or in combination with one another:
the gripping means is located on the front or rear bonnet, or in an area close to the front or rear bonnet of the motor vehicle, in particular on a front or rear wing, or a front or rear bumper, or a front grille;
it comprises a security device intended to prevent use of the gripping means to unlock the bonnet lock by an unauthorized person;
said arrangement comprises an authentication means which interacts with the security element, such that the gripping means may be used only when an identification object identifying a user is authenticated by the authentication means;
it is an electric vehicle and the gripping means is a flap of a charging port of the electric vehicle;
the authentication means interacts with a locking/unlocking device of the charging port of the motor vehicle, such that it is capable of unlocking the closed charging port, in particular the closed flap of the charging port, after authentication of the identification object;
the authentication means interacts with the security element of the lock of the motor vehicle such that it is capable of unlocking the cable after authentication of the identification object, in particular of releasing the mechanical connection between the charging port and the cable;
it comprises an identification object capable of interacting with a locking/unlocking device of the motor vehicle to allow or prevent access to the passenger compartment of the motor vehicle, and the same identification object is capable of interacting with the authentication means of said arrangement to make it possible to unlock the lock of the bonnet by pivoting the flap and/or said locking device of the charging port of the motor vehicle;
it comprises a charging cable for charging the battery of the electric motor vehicle positioned in a housing located under the bonnet of the vehicle, in particular the front bonnet.

The invention also relates to a method for unlocking a bonnet of a motor vehicle as claimed in one of the preceding claims, comprising a step of rotating the gripping means of the arrangement, the gripping means being located outside the passenger compartment.

The invention also relates to a method for charging an electric motor vehicle as mentioned above, which comprises the following steps:
a step of opening a charging port flap of the vehicle between a closed position and a stable locking position in which the cable is rigidly secured to the charging port,
a step of pulling on the gripping means of the arrangement for unlocking a bonnet of the vehicle, this gripping means being the flap of the charging port;
a step of taking hold of a charging cable in a housing located under the bonnet of the vehicle,
a step of connecting an electric vehicle charging terminal to a charging interface of the port by means of the charging cable,
a step of immobilizing the cable while the vehicle is charging, all of the steps of the method taking place outside the passenger compartment of the motor vehicle.

The attached drawing shows, by way of example, an embodiment of an unlocking arrangement according to the invention and a mode of implementation of an unlocking method according to the invention.

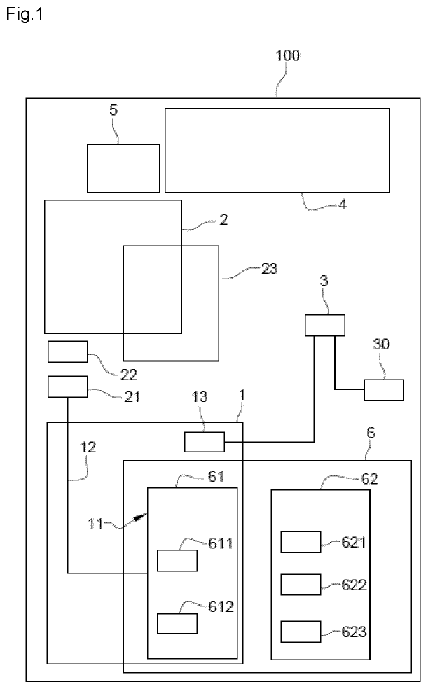

FIG. 1 shows a vehicle equipped with an unlocking arrangement according to the invention,

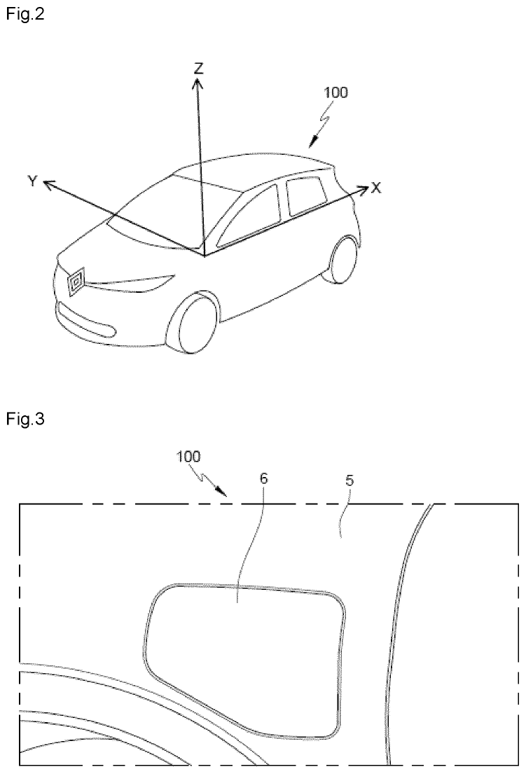

FIG. 2 defines an orthonormal reference frame of the motor vehicle,

FIG. 3 is a first perspective view of a charging port in the closed position on a body element of the vehicle,

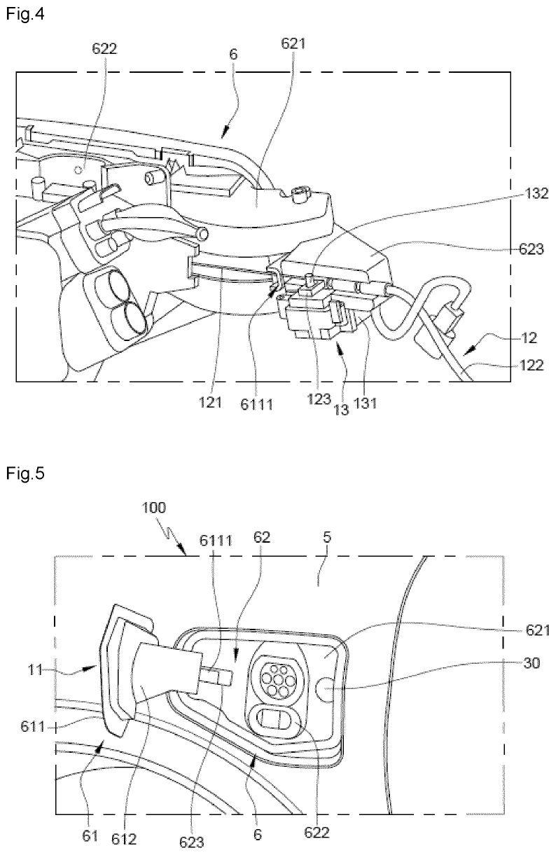

FIG. 4 is a perspective view showing, from the rear, a charging port 6 and the unlocking arrangement,

FIG. 5 is a perspective view of the charging port of FIG. 3 in a stable open position,

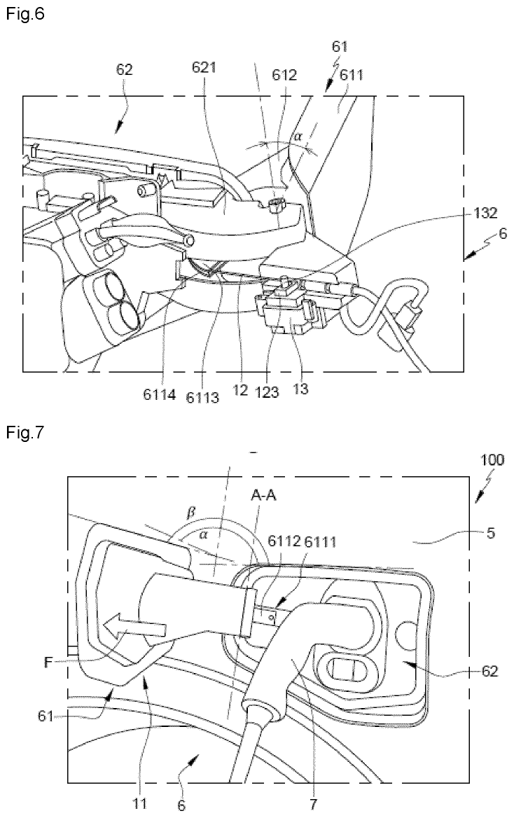

FIG. 6 is a perspective view showing, from the rear, a charging port in the open position of FIG. 5 and the unlocking arrangement,

FIG. 7 is a perspective view of the charging port shown between the stable open position of FIGS. 5 and 6, and a maximum open position allowing the bonnet lock to be unlocked according to the invention,

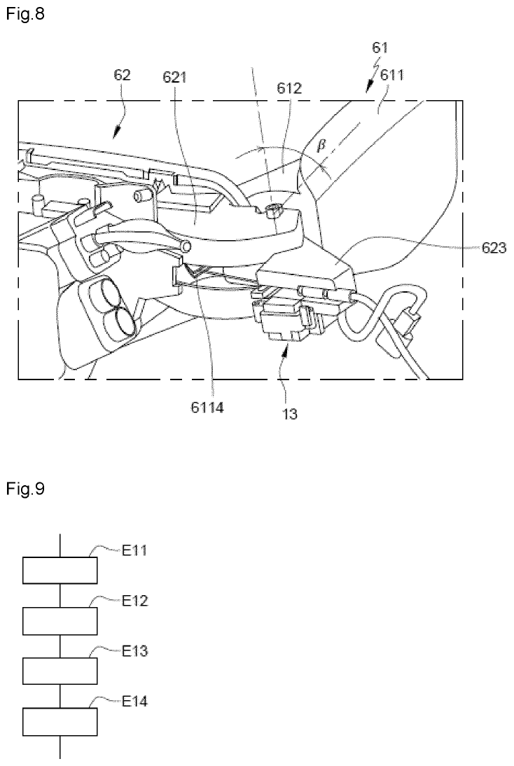

FIG. 8 is a perspective view showing, from the rear, a charging port in the open position of FIG. 7 and the unlocking arrangement,

FIG. 9 is a flow chart of a method for unlocking a front bonnet according to the invention,

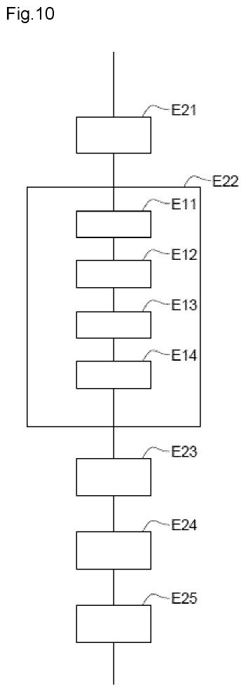

FIG. 10 is a flow chart of a method for charging an electric vehicle according to the invention.

An example of a vehicle 100 equipped with an embodiment of an arrangement for unlocking a front bonnet is described below with reference to FIG. 1.

The motor vehicle 100 is a motor vehicle of any type, including a passenger vehicle or a utility vehicle. The motor vehicle 100 may be equipped with a combustion and/or electric engine.

In the remainder of the document, the figures are defined in relation to a direct orthonormal reference frame (X, Y, Z) represented by FIG. 2, the axis X being parallel to the longitudinal axis of the motor vehicle 100 and oriented towards the rear of the motor vehicle 100, and the axis Z being vertical and oriented towards the top of the vehicle.

The motor vehicle 100 comprises a passenger compartment 4 and a front bonnet 2. The front bonnet comprises at least one lock 21 which secures the opening of the bonnet 2. The lock 21 is connected to an arrangement 1 for unlocking the lock 21.

In one embodiment, the motor vehicle 100 may comprise a space which may serve as a storage compartment 23, in particular for storing cables for connecting the vehicle to a charging terminal. The storage compartment 23 is located in a receptacle made accessible by opening the front bonnet 2.

The arrangement 1 comprises a gripping means 11 and a cable 12 connecting the lock 21 to the gripping means 11. The gripping means 11 is accessible to a user from outside the passenger compartment 4 and no portion of the cable is located inside the passenger compartment 4 of the vehicle 100. Thus, the cable is positioned entirely outside the passenger compartment 4.

The gripping means 11 is located at a port 6 located in an area close to the front bonnet 2 of the vehicle, in particular on a front wing 5 or a front bumper or a front grille of the vehicle.

In an advantageous embodiment, the vehicle 100 is an electric vehicle and the gripping means 11 is a charging port 6 of the vehicle 100.

The port 6 comprises a flap 61 having a cosmetic part 611 visible from the outside and an interior lining 612. The port 6 further comprises an inner wall or bowl 62. As can be seen in particular in FIGS. 4, 5 and 8, the bowl 62 is a rigid end wall 621 supporting in particular an electric charging plug interface 622. The end wall 621 therefore comprises an opening having a shape complementary to that of the interface 622 which is intended to be connected to an electric charging plug 7, as can be seen in FIG. 7. The bowl 62 is shaped according to an opening made on the front wing such that it may be mounted from the outside in such a way that in the closed position of the charging port 6, the latter lies flush with the front wing 5 as shown in FIG. 3.

The charging port 6 is composed of a flap 61 hinged rotatably on a bowl 62 about the axis A-A. The flap 61 in the closed position is connected to the bowl by means of a locking/unlocking device 30 which is commonly referred to as a “push-pull mechanism”, located on the opposite side to the axis A-A of rotation. When the flap 61 is pressed in line with the locking mechanism, a retractable finger comprising radial fins moves back and pivots, causing a 90 degree rotational movement of the fins, thus releasing the connection between the flap 61 and the locking mechanism. When the bearing pressure is released, the retractable finger exerts a pushing force in order to place the flap 61 in a slightly open position, which then makes it easier for a user to take hold of it. The locking/unlocking device 30 is assembled to an end wall 621 of the bowl 62, as can be seen in FIG. 5 in particular.

The arrangement 1 and the lock 21 interact such that a pulling force exerted by a user on the cable 12 via the gripping means 11 unlocks the lock 21.

Thus, after having exerted a pulling force on the gripping means, the user moves towards the front bonnet 2 which is located near the gripping means 11. In one embodiment of the front bonnet 2, the user may then directly open the front bonnet 2. Alternatively, the bonnet 2 may, for example, further comprise a latch 22. In this case, when the lock 21 is unlocked, the bonnet opens slightly. To fully open the front bonnet 2, the user must then unlock the latch 22 by passing their hand through the bonnet opening.

An embodiment of an arrangement 1 is shown in FIGS. 3 to 8. According to this arrangement 1, the gripping means 11 is the flap 61 of the port, it may also be described as a handle or paddle operable by a user's hand.

The gripping means 11 is connected to the cable 12 which is concealed by its sheath 122.

The arrangement 1 advantageously comprises a security element 13 intended to prevent unauthorized use of the gripping means 11.

In the remainder of the document,
the security element 13 is said to be “deactivated” when it allows the use of the gripping means 11; and
the security element is said to be “activated” when it prevents the use of the gripping means 11 to unlock the bonnet lock.

In FIGS. 4 and 6, the security element 13 is shown in the “activated” state, and in FIG. 8 in the “deactivated” state. The security element comprises a fixed part 131 and a movable part 132.

The fixed part 131 is assembled to the bowl 62 of the charging port which comprises for this purpose an attachment interface 623 forming a fixed and rigid structure of the bowl 62. The fixed part 131 contains the mechanism which controls the movable part 132.

The movable part 132 comprises a retractable finger which is able to move perpendicular to the cable 12, as will be described in detail below. The attachment interface 623 comprises a receiving groove 6231 at the end of the sheath of the cable 12. The groove has a substantially cylindrical profile, through which extend in radial projection two ribs forming axial retention stops vis-à-vis the movement of the sheath 122 of the cable 12.

The security element 13 is arranged under the receiving groove 6231 such that the movable part 132 comes close to the cable 12 in the activated state of the security device 13.

The cable 12 comprises a flexible strand 121, in particular made of metal, on which a slider 123 is crimped as shown in FIGS. 4, 6 and 8. The slider 123 is of substantially rectangular geometry and has a space 113, in particular an opening, for example a through hole, intended to receive the movable part 132 in the active state of the security device 13.

The security device 13 is connected to the on-board electronic network by a connector 124 in order to allow switching between the “activated” and “deactivated” states. This connector 124 may be connected to a control unit which may be linked to an authentication means 3 or a remote control (not shown).

The movable part 132 is intended to interact with a space made in the cable 12 so as to form together a means of connection between the security element 13 and the cable 12. The space provides a female component of the cable 12 and the movable part 132 provides a male component of the connecting means.

The cable 12 comprises a flexible strand 121, in particular made of metal, on which a slider 123 is crimped as shown in FIGS. 4, 6 and 8. The slider 123 is of substantially rectangular geometry and has a space, in particular an opening, for example a through hole, intended to receive the movable part 132 in the active state of the security device 13.

When the security element 13 is activated, as shown in FIGS. 4 and 6, the retractable finger of the movable part 132 is held protruding inside the slider 123. The cable is attached to the security element 13, which blocks the cable 12, or at least immobilizes the strand 121 on the security element 13 rigidly secured to the fixed and rigid structure of the bowl 62. Therefore, when the security element 13 is activated, it is impossible to move the strand 121 relative to the sheath of the cable 12.

Conversely, when the security element 13 is deactivated, as shown in FIG. 8, the slider 123 is no longer engaged with the security element 13 such that the strand 121 is free to move relative to the sheath 122 of the cable 12.

The flap 61 is capable of taking up three positions:
a closed position, in which the electric charging plug interface 622 is made inaccessible, as can be seen in FIG. 3,
a stable open position, in which the interface 622 is made accessible for the electrical connection of a charging plug; as can be seen in FIG. 5, the flap 61 is parallel to the axis B-B,
a maximum open position, for unlocking the front bonnet lock; as can be seen in FIGS. 7 and 8, the flap 61 is offset by an angle of opening β which is greater than the angle a that the flap occupies in a stable position, relative to its closed position.

The stable open state of the flap 61 is obtained by immobilizing the flap 61 via the cable 12 which is then retained by the security device 13. The transition from the stable open position to the maximum position for unlocking the front bonnet lock is achieved via a manual action, i.e. a force in the direction of the arrow F in FIG. 7 which causes a rotation of the flap about the axis A-A. This has the effect of pulling the cable strand 121 relative to the sheath 122 so as to unlock the bonnet lock. The interior lining 611 of the flap 61 comprises for this purpose an indexing wall 6111 located near the hinge zone. The indexing wall 6111 for indexing the cable through which the cable strand 121 extends.

The indexing wall 6111 has a dual role:
over a first angular travel between the closed position of the flap 61 and the stable open position, the strand 121 of the cable 12 is mounted to slide freely through the indexing arm,
over a second angular travel, between the stable open position and the maximum open position, the indexing wall 6111 exerts a tensile force on the cable strand 121 by means of an end stop, in particular a spherical stop, also described as an end olive with reference to its geometry.

In the closed state, the indexing wall 6111 is located close to, or even resting against, the attachment interface 623 forming a fixed, rigid and protruding structural part of the bowl 62, as can be seen in FIG. 4. The indexing wall 6111 comprises an end face 6112 which extends substantially radially to the hinge zone of the interior lining 611 of the flap 61, as can be seen in particular in FIG. 5. The end face 6112 is extended towards the rear by a disk portion 6113 the side of which comprises a groove 6114 inside which the strand 121 may be housed during the maneuvering of the gripping means 11. The geometry of the indexing wall 6111, that is to say the position of the end face and/or the radius of the disk portion 6113 is thus defined according to the useful travel of the strand 121 to unlock the front bonnet lock.

In the closed state, the end stop of the strand 121 is moved away from the end face 6112 of the indexing wall 6111, as can be seen in FIG. 4. Between the closed position of FIG. 4 and the stable open position of FIG. 6, the cable strand 121 slides along the end face while at the same time being placed inside the groove 6114 of the disk portion 6113 in such a way that in the stable state, the end stop of the strand 121 bears against the end face 6112.

In the “activated” state of the security device 13, the slider is rigidly secured to the structure of the bowl 62 by means of the retractable finger of the movable part 132 of the security device which is then in the deployed position.

In the “deactivated” state of the security device 13, the pivoting of the gripping means 11 from the stable open position to the maximum position is made possible, which has the consequence of pulling on the strand 121 in order to manually unlock the front bonnet lock by pivoting the flap 61 of the charging port 6. For example, a pull on the gripping means 11, with the strand 121 sliding by 20 millimeters in its sheath 122, allows the unlocking of the lock, which corresponds approximately to ϕ=β−α between 10° and 20° about the axis A-A.

In a preferred embodiment, the motor vehicle further comprises an authentication means 3 for authenticating a user of the vehicle which controls the security element 13, such that
if a vehicle user is authenticated near the vehicle, the security element 13 is deactivated,
otherwise the security element 13 is activated.

Thus, the gripping means 11 may be used to unlock the front lock only when a person located near the vehicle is recognized by the authentication means 3 as being a user of the vehicle.

Said authentication means 3 for authenticating a user of the vehicle is also linked with a locking/unlocking device 30 of the charging port 6 of the vehicle 100.

Said authentication means 3 thus controls the locking/unlocking device 30, such that
if a vehicle user is authenticated near the vehicle, the locking/unlocking device 30 is in the “deactivated” state, such that it makes it possible to unlock the closed port 6,
otherwise the locking/unlocking device 30 is in the “activated” state, the charging port 6.

The authentication means 3 for authenticating a user may for example recognize a magnetic card or key, more generally any object for identification of a person, allowing automatic unlocking of the vehicle when a user is located within a given perimeter around the vehicle 100, for example less than two meters from the vehicle. In this embodiment, the authentication means could allow the gripping means to be used only when the vehicle doors are unlocked.

Other embodiments of the authentication means 3 may be envisaged. The bowl 62 may comprise an opening 623 through which the indexing wall 6111, at least the end face 6112, is capable of circulating freely such that the geometry of the bowl has no impact on the geometry of the unlocking device.

In the event of an attempt to force the arrangement, resulting in breakage of the flap 61 and the indexing wall 6111, the cable may be released but not actuatable because the security device 13 remains engaged with the slider 123, which prevents any relative movement of the strand 121 with respect to the sheath 122 of the cable 12.

According to an alternative embodiment not shown, the indexing wall 6111 is shaped in such a way as to move continuously behind the bowl 62 such that the latter does not have the aforementioned opening. This makes it possible to make the cable 12 and the security element 13 inaccessible, and they are then protected from any fraudulent use, when the flap 61 is in the stable open state.

As the spring of the front bonnet lock exerts a force opposite to that applied by the gripping means 11 for unlocking, the strand 121 tends to return the flap 61 from the maximum open position to the stable open position. As a result, as soon as the gripping means 11 is released by the user, the gripping means 11 is thus automatically put back into its stable open position. The cable slider 123 may again be positioned in line with the retractable finger of the movable part 132 such that in the absence of user authentication, the retractable finger returns to its position protruding inside the slider.

A mode of implementation of a method for unlocking a front bonnet 2 of a motor vehicle 100 comprising an arrangement 1 according to the invention is described below with reference to FIG. 9.

The method comprises an unlocking step E14 in which the user exerts a pulling force on the gripping means 11 of the arrangement 1, the gripping means 11 being located outside the passenger compartment 4; it is in particular a flap 61 of the charging port 6.

In order to be able to exert a pulling force, the user must, in a first sub-step E11, deactivate the security device 13 of the arrangement 1. In one embodiment, deactivation is performed using a magnetic fob or magnetic key which may be the key or the fob, more generally any identification object, used to unlock the vehicle.

Next, the user must, in a second sub-step E12, press on the gripping means 11, so as to disengage it from the charging port opening, the gripping means 11 then being in the slightly open position to make it possible for a user to manipulate it.

Then, in a third sub-step E13, the user exerts a rotation force on the flap 61 such that the strand 121 of the cable 12 takes its place within an indexing wall 6111, the flap 61 then being moved from the slightly open position to the stable open position.

Next, in a fourth sub-step E14, the user exerts an additional force, greater than that of step E13, and tending to overcome the resistance exerted by the spring of the bonnet lock, thus moving the strand 121 inside the sheath 122, which unlocks the front bonnet lock. The flap 61 is thus moved between the stable open position and the maximum open position.

The strand 121 moves by around a few centimeters, for example two centimeters such that the angular travel of the flap 61 between the stable open position and the maximum open position is greater than the few centimeters required to unlock the front bonnet lock. Once the bonnet is unlocked, the tension exerted by the strand 121 on the gripping means 11 of flap 61 type tends to mechanically return the gripping means 11 to the stable open position, when the user releases the flap. The lock 21 of the front bonnet 2 is then unlocked.

A mode of implementation of a method for charging an electric motor vehicle 100 according to the invention is described below with reference to FIG. 10.

In a first step E21, the user opens the charging port 6 of the motor vehicle 100. In one embodiment, the opening of the port 6 is secured by a user authentication means, using, for example, a magnetic fob or a magnetic key.

In a second step E22, the user exerts a pulling force on the gripping means 11 of the arrangement 1 for unlocking a front bonnet 2 of the vehicle.

The second step E22 is broken down into four sub-steps E11 to E14, which were described above in the mode of implementation of the method for unlocking a front bonnet. Note that sub-step E11 of deactivating the security element 13 may advantageously be carried out by the same means as the unlocking of the port 6 carried out in step E21. In other words, it is the same fob or the same magnetic key, more generally any identification object, which allows the port 6 to be unlocked and the security element 13 to be deactivated. At the end of step E22, the lock 21 of the front bonnet 2 is unlocked.

In a third step E23, the user takes hold of a charging cable in a housing 23 located under the front bonnet 2 of the vehicle. To do this, the user moves from the port 6 to the front bonnet 2 of the vehicle. They then open the front bonnet 2 (previously unlocked during step E22) to take hold of the cable and close the front bonnet 2. Opening the front bonnet 2 may require pivoting of an additional security lever, of unlocking latch 22 type, fitted on the lock 21.

In a fourth step E24, the user connects an electric vehicle charging terminal to a charging interface 622 of the port 6 via the charging cable. In a fifth step E25, the connection of the charging cable to the charging interface 622 causes the strand 121 to be immobilized vis-à-vis the port 6. During this step the user may move away from their vehicle while the port 6 remains open for charging the vehicle. When the user moves away from their vehicle, the authentication means 3 detects that the user has left and activates the security element 13 of the arrangement, such that the strand 121 connecting the front bonnet lock 21 to the gripping means 11 cannot be used to unlock the front bonnet of the vehicle while it is charging.

Lastly, the arrangement 1 according to the invention makes it possible to install a front bonnet unlocking system outside the passenger compartment 2. This arrangement avoids a user who has already got out of the vehicle having to return to the passenger compartment to activate a bonnet opening mechanism.

Therefore, a user who has got out of their vehicle, for example to operate a charging terminal, does not need to return to the passenger compartment of the vehicle if they want to retrieve charging cables stored under the front bonnet of the vehicle.

Advantageously, the arrangement 1 may be installed at an electric charging port, which reduces the number of trips the user has to make around their vehicle when charging the vehicle.

In the case where the arrangement 1 is installed near the front bonnet, the invention also makes it possible to reduce the length of the cable strand 121 connecting the bonnet lock to the flap 61 used as a gripping means 11, and also to reduce the length of the sheath of this cable. A smaller cable allows for a better unlocking action, as the cable tension may be lower and the cable travel may be reduced.

The embodiments of the arrangement 1 also make it possible to secure access to the engine compartment. In particular, the invention blocks attempts to fraudulently use the arrangement 1.

Furthermore, the cost of implementing the invention is limited. This is because the invention does not modify the technical features or the design of the front bonnet 2 and the lock 21. Moreover, the proposed solution reuses mechanisms already present on the vehicle, in particular the “push-pull” type system used as an element for opening the flap 61 of the port 6 which is used to secure the flap of the port 6 in the closed state.

1-11. (canceled)

12. A motor vehicle comprising:
an arrangement for unlocking a lock of a bonnet, the arrangement comprising a gripping means and a cable connecting the lock of the bonnet to the gripping means,
wherein the gripping means is accessible to a user from outside a passenger compartment of the motor vehicle and the cable is positioned entirely outside the passenger compartment of the motor vehicle.

13. The motor vehicle as claimed in claim 12, wherein the bonnet is a front bonnet of the motor vehicle.

14. The motor vehicle as claimed in claim 12, wherein the gripping means is located on the front or rear bonnet, or on a front or rear wing, or a front or rear bumper, or a front grille.

15. The motor vehicle as claimed in claim 12, further comprising a security device configured to prevent use of the gripping means to unlock the lock of the bonnet by an unauthorized person.

16. The motor vehicle as claimed in claim 15, wherein said arrangement comprises an authentication means which interacts with the security device such that the gripping means is configured to be used only when an identification object identifying a user is authenticated by the authentication means.

17. The motor vehicle as claimed in claim 12, wherein the motor vehicle is an electric vehicle and the gripping means is a flap of a charging port of the electric vehicle.

18. The motor vehicle as claimed in claim 16, wherein the motor vehicle is an electric vehicle and the gripping means is a flap of a charging port of the electric vehicle, and the authentication means interacts with a locking/unlocking device of the charging port of the motor vehicle such that the authentication means is configured to unlock the closed charging port after authentication of the identification object.

19. The motor vehicle as claimed in claim 18, wherein the authentication means interacts with the security element of the lock of the motor vehicle such that the authentication means is configured to unlock the cable after authentication of the identification object by releasing a mechanical connection between the charging port and the cable.

20. The motor vehicle as claimed in claim 16, further comprising an identification object configured to interact with a locking/unlocking device of the motor vehicle to allow or prevent access to the passenger compartment of the motor vehicle, and the identification object is configured to interact with the authentication means of said arrangement to make it possible to unlock the lock of the bonnet by pivoting a flap and/or said locking device of a charging port of the motor vehicle.

21. The motor vehicle as claimed in claim 17, further comprising a charging cable for charging the battery of the electric motor vehicle positioned in a housing located under the bonnet of the vehicle.

22. A method for unlocking the bonnet of the motor vehicle as claimed in claim 11, comprising:
rotating the gripping means of the arrangement, the gripping means being located outside the passenger compartment.

23. A method for charging the motor vehicle as claimed in claim 21, comprising:
opening the flap of the charging port of the vehicle between a closed position and a stable locking position in which the charging cable is rigidly secured to the charging port;
pulling on the gripping means of the arrangement for unlocking the bonnet of the vehicle, the gripping means being the flap of the charging port;
taking hold of the charging cable in the housing located under the bonnet of the vehicle;
connecting an electric vehicle charging terminal to a charging interface of the port via the charging cable; and
immobilizing the cable while the vehicle is charging,
wherein all steps of the method take place outside the passenger compartment of the motor vehicle.
